(19) United States
(12) Patent Application Publication
(10) Pub. No.: US 2009/0121061 A1
(43) Pub. Date: May 14, 2009

(54) Robot system and method for unblocking the primary crusher

(76) Inventor: Hugo Salamanca, Santiago (CL)

Correspondence Address: GOTTLIEB RACKMAN & REISMAN PC, 270 MADISON AVENUE, 8TH FLOOR, NEW YORK, NY, 10016-0601, US

(21) Appl. No.: 11/598,138

(22) Filed: Nov. 13, 2006

Related U.S. Application Data
(60) Provisional application No. 60/734,990, filed on Nov. 10, 2005.

(51) Int. Cl. A47J 17/18; B02C 23/00

(52) U.S. Cl. 241/166; 241/33; 901/15

(57) ABSTRACT

At present, the unblocking of the primary crusher is carried out manually or using mechanical equipment which means the crusher stops for a long time and is less available. There is also a high level of exposure to the risks associated to unblocking procedures.

Due to the above, a robot system and method have been developed for unblocking primary crushers.

The system is composed mainly of an anthropomorphous robotic manipulator of at least 5 degrees of freedom, and a system to unclog or release the crusher. In this regard, most of the problems associated to the safety of the people and less availability decrease.

### CROSS-REFERENCE TO RELATED APPLICATIONS

This application claims the benefit of provisional patent application Ser. No. 60/734,990 filed 2005 Nov. 10 by the present inventor

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry to improve the remove the material or the object clogging the primary crushers, specifically in the mining area.

2. Prior Art

During the process of metal extraction, the ore which has been recently extracted from the mine is considered not suitable for the industrial treatment due to the unevenness level in the granulometry and because the material it is too big. Thus, it is necessary to reduce the size of the ore to a suitable size, which is carried out in different stages of particle size reduction such as crushing, triturating and grinding, and according to the reduction level required.

The crushing process is intended to reduce the mine layers to its adequate size which commonly considers three or four stages of crushing.

The primary crushing process reduces the material to 8″, by sending the product to a pile for coarse material. From there, the material passes through conveyor belts to the secondary crushing section reducing the ore to 4″. Then, it passes to the tertiary crushing process which commonly works in a closed circuit with a plant of sieves, which accepts the mineral under the required granulometry, and the ore with a greater granulometry circulates.

Finally the ore reaches a size of about ⅜ or ¼″.

Nevertheless, in the process of crushing and due to the operation itself, some foreign elements enter the mineral flow of the different processes, specially in underground mines, causing the crusher to clog in many occasions.

The process of unblocking the primary crusher is one of the current procedures for the operation of the crushing system. In this activity, supporting mechanical tools are used.

To carry out this activity demands a physical effort and a risky operation from the personnel in charge, with the subsequent risk of a fatal accident for those carrying out the activity.

Another important aspect is the time the activity takes, which implies less availability of the equipment, leading to great losses of productivity.

The task of unblocking the primary crusher as it is done at present has some disadvantages such as:
Less availability of the equipment, which implies a loss in productivity.
Costs associated to personnel involving the manual and/or mechanical reposition.
Unblocking the primary crusher is a task with a high accident risk level.
The operators in charge of the manual reposition are subjected to a constant physical demand.

### SUMMARY

A robot system and method have been developed for the unblocking procedure of the primary crusher so as to automate such dangerous activity

### DRAWINGS—FIGURES

In the drawings, closely related figures share the same numbers, with different alphabetic suffixes.

FIG. 1. General view of a robot system.

FIG. 2. General view of a robot system unblocking the crusher.

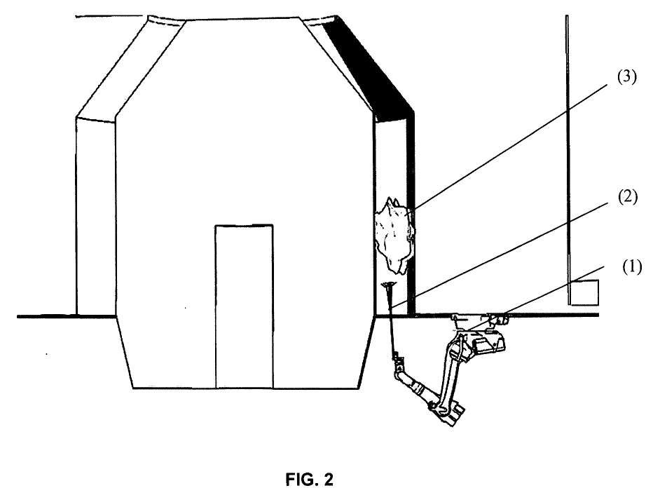

### DRAWINGS—REFERENCE NUMERALS

1. Robotic manipulator
2. Set of tools
3. Object causing the clogging

### DETAILED DESCRIPTION

This invention relates to a new robot system as well as a robotic method for unblocking the primary crusher, which is carried out automatically through anthropomorphous robotic arms of at least 5 degrees of freedom, which are mounted on the bottom part of the crusher.

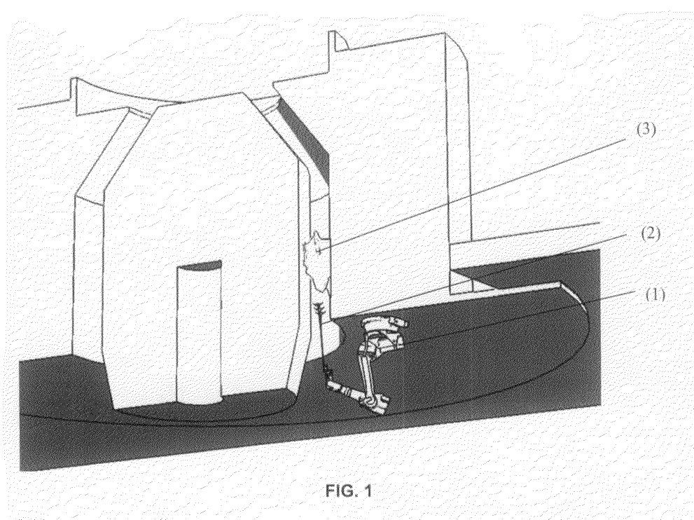

With reference to FIG. 1, the robot system for unblocking the primary crusher is composed mainly of one anthropomorphous robotic manipulator of at least 5 degrees of freedom (1), provided with a communication, acquisition and control system, and a gripping mechanism to take, manipulate, and release, a set of tools (2) which are used to remove the material or the object (3) causing the clogging. The operator indicates the beginning of the activity and some key parameters for the development of the activity.

I claim:

1. A robot system for unblocking the primary crusher comprising an anthropomorphous robotic arm of at least 5 degrees of freedom, one control, communication and programming unit, one gripper adapter, one pneumatic gripper, its fingers, one pneumatic gripper driving system, one electric supply system wherein the anthropomorphous robotic arm of at least 5 degrees of freedom is provided with a pneumatic or hydraulic gripping mechanism which allows to take, manipulate and release in a sequential and programmed way different tools within the work volume of the robotic system, and which are moved through a defined path, to the primary crusher in which they are used to remove the material or the object clogging the primary crusher.

2. A robot system for unblocking the primary crusher according to claim 1, wherein a gripping mechanism to take, manipulate and release different tools within the work volume of the robotic system is used. These tools are moved through a defined path to the primary crusher in which the material or the object clogging the primary crusher is removed.

3. A robot system for unblocking the primary crusher according to claim 1, wherein a pneumatic or hydraulic gripping system to take, manipulate and release the different tools is used.

4. A robot system for unblocking the primary crusher according to claim 1, wherein the anthropomorphous robotic manipulator could communicate by itself or through a PLC interface with the control system.

5. A robot system for unblocking the primary crusher according to claim 1, wherein the anthropomorphous robotic manipulator has the capacity to obtain and interpret the information from installed analogue and/or digital sensors.

6. A robot system for unblocking the primary crusher according to claim 1, wherein the anthropomorphous robotic manipulator has the capacity to generate analogue and/or digital signals to control analogue and/or digital input devices.

7. A robot system for unblocking the primary crusher according to claim 1, wherein the manipulator uses different tools within the work volume of the robotic system which are moved through a defined path to the primary crusher in order to remove the material or the object causing the clogging of the crusher.

8. A robot system for unblocking the primary crusher according to claim 1, wherein the anthropomorphous robotic manipulator has an electrical system driven by three-stage induction motors, with vectorial and/or scalar control.

9. A robot system for unblocking the primary crusher according to claim 1, wherein is has the capacity of moving and manipulating the tools in different paths within the work volume of the robotic system.

10. A robot system for unblocking the primary crusher according to claim 1, wherein productivity and efficiency of the crushing process increases.

11. A robot system for unblocking the primary crusher according to claim 1, wherein the system may operate automatically, or semiautomatically, and also allows solutions scalability.

12. A robot system for unblocking the primary crusher according to claim 1, wherein the system could be integrated to the process of unblocking the primary, secondary or tertiary crushers.

13. A robot system for unblocking the primary crusher according to claim 1, wherein it prevents the plant personnel from being subjected to a high physical demand and harsh environmental conditions.

14. A robotic method for unblocking the primary crusher using the robot System of claim N^{o}1 to N^{o}13, wherein the anthropomorphous robotic arm of at least 5 degrees of freedom is provided with a pneumatic or hydraulic gripping mechanism which allows to take, manipulate and release in a sequential and programmed way several tools within the work volume of the robotic system and move them through a defined path to the primary crusher in which they are used to remove the material or the object causing the clogging in the crusher.

15. A robotic method for unblocking the primary crusher using the robot System of claim N^{o}1 to N^{o}13, wherein the anthropomorphous robotic manipulator could communicate by itself or through a PLC interface with the control system.

16. A robotic method for unblocking the primary crusher using the robot System of claim N^{o}1 to N^{o}13, wherein the anthropomorphous robotic manipulator has the capacity to obtain and interpret the information from installed analogue and/or digital sensors.

17. A robotic method for unblocking the primary crusher using the robot System of claim N^{o}1 to N^{o}13, wherein the anthropomorphous robotic manipulator has the capacity to generate analogue and/or digital signals to control the analogue and/or digital inputs devices

18. A robotic method for unblocking the primary crusher using the robot System of claim N^{o}1 to N^{o}13, wherein a gripping mechanism is used to take, manipulate and release the different tools, within the work volume of the robotic system and are moved through a defined path to the primary crusher to remove the material or the object causing the clogging in the crusher.

19. A robotic method for unblocking the primary crusher using the robot System of claim N^{o}1 to N^{o}13, wherein the robotic manipulator has a pneumatic or hydraulic gripping mechanism which allows to take, manipulate and release the different tools.

20. A robotic method for unblocking the primary crusher using the robot System of claim N^{o}1 to N^{o}13, wherein it uses different tools within the work volume of the robotic system, which are moved through a defined path to the primary crusher to remove the material or the object causing the clogging in the crusher.

21. A robotic method for unblocking the primary crusher using the robot System of claim N^{o}1 to N^{o}13, wherein the anthropomorphous robotic manipulator has an electrical system driven by three-stage induction motors with vectorial and/or scalar control

22. A robotic method for unblocking the primary crusher using the robot System of claim N^{o}1 to N^{o}13, wherein it has the capacity to move and manipulate the tools in the different paths within the work volume of the robotic system.

23. A robotic method for unblocking the primary crusher using the robot System of claim N^{o}1 to N^{o}13, wherein productivity and efficiency of the crushing process increases.

24. A robotic method for unblocking the primary crusher using the robot System of claim N^{o}1 to N^{o}13, wherein the system may operate automatically or semiautomatically, and also allows solution scalability.

25. A robotic method for unblocking the primary crusher using the robot System of claim N^{o}1 to N^{o}13, wherein the system could be integrated to the unblocking process of the primary, secondary and/or tertiary crushers.

26. A robotic method for unblocking the primary crusher using the robot System of claim N^{o}1 to N^{o}13, wherein it prevents the plant personnel from being subjected to a high physical demand and harsh environmental conditions
